(19) United States
(12) Patent Application Publication
(10) Pub. No.: US 2007/0149085 A1
(43) Pub. Date: Jun. 28, 2007

(54) Method of manufacturing a crt using a flowcoating process

(76) Inventors: Donald Walter Bartch, York, PA (US); Alan Andrew Halecky, Glenmoore, PA (US); John Stephen Farrah, Lancaster, PA (US); James Francis Edwards, Lancaster, PA (US)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/580,184

(22) PCT Filed: Nov. 15, 2004
(86) PCT No.: PCT/US04/38016

§ 371 Date: May 22, 2006

Related U.S. Application Data
(60) Provisional application No. 60/524,956, filed on Nov. 25, 2003.

(51) Int. Cl. H01J 9/00

(52) U.S. Cl. 445/23

(57) ABSTRACT

The invention incorporates a method of manufacturing a CRT that comprises the application of an internal conductive coating formulation by a flowcoating process on a portion of an interior surface of a funnel and on an interior portion of a neck of the CRT. The formulation comprises iron oxide, graphite, a silicate, a copolymer, surfactant and water. In a preferred embodiment, the copolymer is a maleic copolymer.

### CROSS-REFERENCE TO RELATED APPLICATIONS

This application claims the benefit of U.S. Provisional Patent Application Ser. No. 60/524,956, entitled “Improved Stability Flow Coating Containing Iron Oxide and Maleic Colpolymer” and filed Nov. 25, 2004, which is incorporated by reference herein in its entirety.

### BACKGROUND OF THE INVENTION

This invention relates to a method of making a cathode-ray tube having an internal conductive coating.

### DESCRIPTION OF THE BACKGROUND ART

Cathode-ray tubes usually have a conductive internal coating on the interior walls, which functions to carry a high potential applied at the anode button. A common internal coating consists essentially of particulate graphite, particulate iron oxide, and an alkali silicate binder. Typically, the conductive internal coatings are applied to the walls of the tube by spraying, brushing, or flowcoating an aqueous coating composition. The coatings are dried and then baked in air. The tube is later exhausted and hermetically sealed. Subsequently, under some conditions of operation, arcs may be produced in the tube in the vicinity of the electron-gun mount assembly. Associated with these arcs is a surge of current in the internal coating which may damage external circuit components that are connected to the coating. It is desirable to limit the amount of arcing current passed by the internal conductive coating, at least to levels that do not damage any of the external circuit components.

Internal conductive coatings were initially applied by brushing or spraying. Both of these coating processes have the drawback of yielding coatings which can shed a detrimental quantity of particulate matter. Particulate matter has a propensity of causing arcing inside CRTs during tube operation and processing.

Some cathode ray tube manufacturers had begun to use flowcoating processes, because they gives rise to coating that shed fewer particles than traditionally applied coatings. Additionally, flowcoating is less wasteful than spraying since the runoff is collected and used to coat subsequent funnels. Essentially, flowcoating is a more target specific application method, yielding less waste.

Although the flowcoating process has the above-stated advantages over other application processes for the conductive internal coating, evaluation of flowcoating formulations have revealed they require careful process control and that even dilutions of concentrated flowcoating formulations have limited pot life. When stored in a concentrated dispersion, the flowcoating formulations only have a shelf life of up to about six months.

The commercial flowcoating formulations consist of a nonconducting oxide such as iron oxide or titanium dioxide, graphite, and a silicate binder. The oxides are typically milled in the presence of a dispersing agent and over time soluble silicate in the dispersion bridges the oxide particles causing flocculation. Up to this point only expensive forms of iron oxide made from the pyrolysis of iron pentacarbonyl give rise to a non-flocculating dispersion. Further, no commonly available calcined iron oxides has exhibited good dispersion stability.

As such, the need exists for a flowcoating, internal conductive coating formulation which does not easily flocculate.

### SUMMARY OF THE INVENTION

The invention incorporates a method of manufacturing a CRT that comprises the application of an internal conductive coating formulation by a flowcoating process on a portion of an interior surface of a funnel and on an interior portion of a neck of the CRT. The formulation comprises iron oxide, graphite, a silicate, a copolymer, surfactant and water. The applied flowcoating formulation is dried on the portion of the interior surface of the funnel and on the interior portion of said neck, thereby forming a internal conductive coating which functions to carry a high potential applied at the anode button to the internal components of the CRT. In a preferred embodiment, the copolymer is a maleic copolymer.

### BRIEF DESCRIPTION OF THE DRAWING

FIG. 1 is a partially broken-away longitudinal view of a novel cathode-ray tube of the invention

### DESCRIPTION OF THE PREFERRED EMBODIMENT

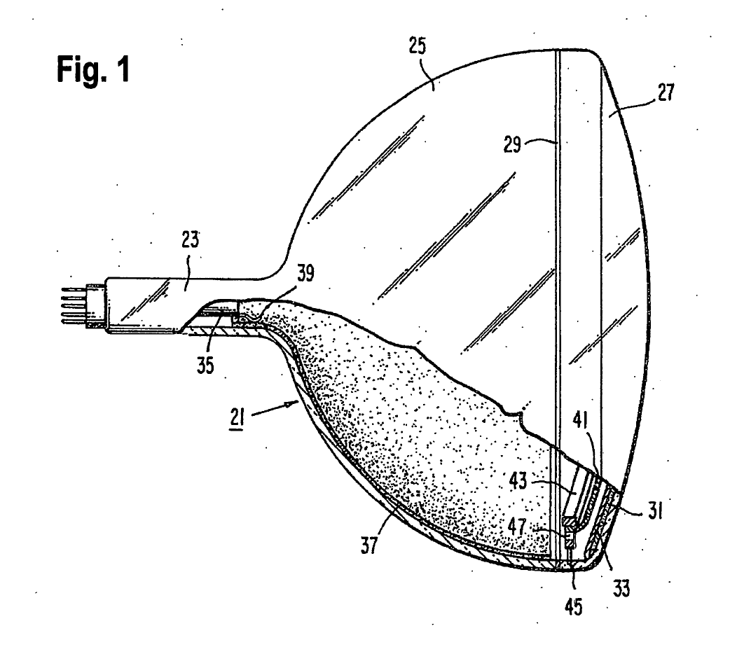

The cathode-ray tube (CRT) illustrated in FIG. 1 includes an evacuated envelope 21, which includes a neck 23 integral with a funnel 25, and a faceplate or panel 27 joined to the funnel 25 by a frit seal 29. The CRT includes a luminescent screen 31 comprised of a phosphor material on the interior surface of the faceplate 27, and a light-reflecting metal coating 33, as of aluminum metal, on the luminescent screen 31. The luminescent screen 31 is scanned by electron beams which pass through a shadow mask 41. The mask 41 is welded to a metal frame 43 supported by springs 47. The springs 47 are attached to the frame 43 and are engaged onto studs 45 that are integral with the panel 27. The electron beams are emitted from a gun in a mount assembly 35 located in the neck 23 to produce luminescent image which may be viewed through the faceplate 27. Shown in FIG. 1 are metal finger 39 that space the mount assembly 35 from the neck 23. The CRT includes an internal conductive coating 37, which is applied to the funnel 25. The internal conductive coating 37 which functions to carry a high potential applied at the anode button to the internal components of the CRT.

The internal conductive coating according to the invention is applied by a flowcoating process. Flowcoating is advantageous because it is a low shear process. As such, flowcoating gives rise to films that shed fewer particles than those coatings applied by the traditional brushed or sprayed coatings. Particles tend to cause arcing that shortens tube life. Additionally, flowcoating is less wasteful than spraying since the runoff is collected and used to coat subsequent funnels. Further, flowcoating is a more target oriented application method than spraying, because during flowcoating the formulation is directly applied to only those areas of the CRT where the internal conductive coating 37 is intended to stay. The spray application on the other hand usually requires shielding to avoid inevitable errand portions of the sprayed formulation from landing on areas of the tube which are not the intended target of the spray. For these reasons tube manufacturers have been moving to flowcoating.

In spite of the known advantages of flowcoating, flowing coating formulations do require careful process control. Thus far, flowcoating formulations have exhibited limited pot life following dilution. As mentioned above, even when they are stored as a concentrate, they have a shelf life of only about six months. Various experiments using dispersing and antiflocculation agents exhibited flocculation when containing a calcined iron oxide and a soluble silicate. It is believed that the binding of silicate chains to acidic sites on the iron oxide particles causes bridging flocculation when the concentration ratio of iron oxide to silicate is less than some threshold value. A plausible explanation is that flocculation is caused by bridging between positively charged sites on the different iron oxide particles by long, negatively charged silicate polymers. Apparently this binding is quite strong. Various experiments with many materials (i.e., aqueous dispersions containing iron oxide, graphite and silicates) have failed to inhibit this binding. However, at a high ratio of silicate to iron oxide, no bridging occurs because many silicate molecules cover the iron oxide surface, which likely changes the charge on the iron oxide particles to a net negative charge. As such, when the silicate to iron oxide ratio is high a good coating may be obtained, but the tradeoff is that with such higher ratios formulation viscosities increase which can yield thicker coatings. Coatings too thick can be prone to flaking.

The invention incorporates as a feature an aqueous dispersion of iron oxide, graphite, a maleic copolymer and a soluble silicate. The presence of the maleic copolymers have extended the shelf life of flowcoating formulations, wherein no flocculation occurs. Additionally the internal conductive coatings formed from these formulations have the requisite electrical, mechanical, and cosmetic properties. In one embodiment of the invention, shown as Example 1, the formulation in concentrated form includes the following components:

### EXAMPLE 1

| | | |
|---|---|---|
| Powdered Graphite | 4-7 | wt. % |
| Metal Oxide | 9-22 | wt. % |
| Negatively Charged Copolymer | 1-5 | wt. % |
| Caustic Material | 1-6 | wt. % |
| Soluble Silicate | 27-46 | wt. % |
| Surfactant | 0.5-5 | wt. % |
| Water | 20-54 | wt. % |

Features of the invention incorporate potassium silicate as the soluble silicate. Other features of the invention include a maleic copolymer as the copolymer that has a negative charge in aqueous media. Further embodiments include iron oxide or titanium dioxide as the metal oxide. Other embodiments include a lignosulphonate as the surfactant

Specific embodiments of the invention incorporate the following example formulations:

### EXAMPLE 2

| | | |
|---|---|---|
| Superior Graphite 5090 Powder | 4.9 | wt. % |
| Asbury Graphite UF-440 Powder | 1.2 | wt. % |
| Ferric Oxide (Fe₂O₃) Powder | 21.9 | wt. % |
| Aquatreat AR-980 Maleic Copolymer | 1.1 | wt. % |
| Ammonium hydroxide | 1.3 | wt. % |
| PQ Kasil 1 | 24.2 | wt. % |
| PQ Kasil 88 | 10.3 | wt. % |
| Marasperse CBOS (20%) | 4.4 | wt. % |
| Water | 30.7 | wt. % |

Superior Graphite 5090 Powder is available from Superior Graphite Co., Chicago, Ill. Asbury Graphite UF-440 Powder is available from Asbury Graphite Mills, Inc., Ashbury, N.J. Aquatreat AR-980 is available from ALCO Chemical, Chattanooga, Tenn. PQ Kasil 1 and Kasil 88 are available from PQ Corp., Valley Forge, Pa. Marasperse CBOS is available from Lignbtech, Greenwich, Conn.

### EXAMPLE 3

| | | |
|---|---|---|
| Graphite Powder | 4.2 | wt. % |
| Ferric Oxide (Fe₂O₃) Powder | 13.4 | wt. % |
| Aquatreat AR-980 Maleic Copolymer | 3.40 | wt. % |
| Potassium Hydroxide | 2.0 | wt. % |
| PQ Kasil 2135 Potassium Silicate | 9.8 | wt. % |
| PQ Kasil 1 Potassium Silicate | 24.5 | wt. % |
| Surfynol DF-110L | 0.01 | wt. % |
| Kraftsperse 1251 | 1.2 | wt. % |
| Deionized Water | 41.49 | wt. % |

Kraftsperse 1251 is available from Mead Westvaco Corp., Charleston, S.C. Surfynol DF-110L is available from Air Products and Chemicals, Allentown, Pa.

### EXAMPLE 4

| | | |
|---|---|---|
| Graphite Powder | 5.76 | wt. % |
| Ferric Oxide Powder | 18.39 | wt. % |
| Aquatreat AR-980 Maleic Copolymer | 4.67 | wt. % |
| Potassium Hydroxide | 2.74 | wt. % |
| PQ Kasil 2135 Potassium Silicate | 16.20 | wt. % |
| PQ Kasil 1 Potassium Silicate | 33.63 | wt. % |
| Surfynol DF-110L | 0.014 | wt. % |
| Tamol 850 | 0.275 | wt. % |
| Tamol SN | 0.137 | wt. % |
| Deionized Water | 18.19 | wt. % |

Tamol 850 and Tamol SN are available from Rohm and Haas Co., Philadelphia, Pa.

In the above embodiments, the formulations resist flocculation, wherein it is believed that negatively charged copolymer molecules tightly adsorbed onto the iron oxide surface prevent silicate binding. The formulations and dilution thereof have exhibited excellent stability in not exhibiting flocculation. Concentrated formulations having solid levels up to 40% and pH below 13.5 have been stable.

The formulations which are actually applied to the funnel 25 are made by diluting the concentrated formulations with water to the extent that the solids concentration is 5 to 30% less than that of the concentrated formulations. Typical viscosities of the concentrated formulations are 40-70 cps in this invention. Typical viscosities of the diluted formulations are 15-30 cps. The formulations in diluted form can include the following:

graphite at 2.8-6.65 wt. %,

metal oxide at 6.3-20.9 wt. %,

copolymer at 0.7-4.75 wt. %,

caustic material at 0.7-5.7 wt. %,

silicate at 18.9-43.7 wt. %,

surfactant at 0.35-4.75 wt. %, and

water at 21-70.2 wt. %.

A positive feature of these formulation is that they are easy to prepare and can be sand milled or high-speed milled in a horizontal mill in continuous flow mode.

What is claimed is:

1. A method of manufacturing a CRT comprising the steps of:
providing an envelope with an interior surface and an exterior surface, said envelope including a faceplate having a luminescent screen on said interior surface thereof, a neck for supporting an electron gun, a funnel connecting said neck and said faceplate;
flowcoating a flowcoating formulation on a portion of said interior surface of said funnel and on an interior portion of said neck, said flowcoating formulation comprises metal oxide, graphite, a silicate, a copolymer, surfactant and water;
drying said flowcoating formulation on said portion of said interior surface of said funnel and on said interior portion of said neck, thereby forming a conductive coating; and
sealing a mount containing said electron gun to said neck, said electron gun having an anode in electrical contact with said conductive coating.

2. The method of claim 1, wherein the copolymer is a maleic copolymer.

3. The method of claim 1, wherein the metal oxide is iron oxide or titanium dioxide.

4. The method of claim 1, wherein the copolymer is at 1-5 weight percent and the metal oxide at 9-22 weight percent.

5. The method of claim 4, wherein the copolymer is a maleic copolymer.

6. The method of claim 4, wherein the metal oxide is iron oxide or titanium dioxide.

7. The method of claim 1, wherein the flowcoating formulation is formed by diluting a concentrated formulation including the following components:
the graphite at 4-7 wt. %;
iron oxide as the metal oxide being at 9-22 wt. %;
maleic copolymer at the copolymer at 1-5 wt. %;
caustic material at 1-6 wt. %;
potassium silicate as the silicate at 27-46 wt. %;
the surfactant at 1-5 wt. %; and
water at 20-54 wt. %.

8. The method of claim 7, wherein the flowcoating formulation was formed by diluting the concentrated formulation such that the concentration of non-aqueous component is 5 to 30% less than that of the concentrated formulations.

9. A formulation for flowcoating comprising metal oxide, graphite, a silicate, a copolymer, surfactant and water.

10. The formulation in claim 9, wherein the formulation is a dispersion in concentrated form comprising
graphite at 4-7 wt. %;
metal oxide at 9-22 wt. %;
copolymer at 1-5 wt. %;
caustic material at 1-6 wt. %;
silicate at 27-46 wt. %;
surfactant at 1-5 wt. %; and
water at 20-54 wt. %;
or a dispersion in diluted form comprising
graphite at 2.8-6.65 wt. %,
metal oxide at 6.3-20.9 wt. %,
copolymer at 0.7-4.75 wt. %,
caustic material at 0.7-5.7 wt. %,
silicate at 18.943.7 wt. %,
surfactant at 0.35-4.75 wt. %, and
water at 21-70.2 wt. %.
